(19) United States
(12) Patent Application Publication
(10) Pub. No.: US 2006/0081799 A1
(43) Pub. Date: Apr. 20, 2006

(54) Method and device for triggering an actuator in a mass-flow line

(76) Inventors: Andre Wittmer, Holzkirchen (DE); Peter Albrecht, Herbertshausen (DE)

Correspondence Address: KENYON & KENYON LLP, ONE BROADWAY, NEW YORK, NY, 10004, US

(21) Appl. No.: 11/246,638

(22) Filed: Oct. 7, 2005

(30) Foreign Application Priority Data
Oct. 7, 2004 (DE) 10 2004 048 860.6

(51) Int. Cl. F16K 31/12; F16K 31/44; F02D 23/00

(52) U.S. Cl. 251/14; 60/602; 251/310

(57) ABSTRACT

A method and a device for triggering an, in particular pneumatic, actuator in a mass-flow line is provided, which allow for a precise setting of the actuator without automatic position control and position feedback. For this purpose, a setpoint position is provided for setting the actuator. An actuating variable is provided for setting the setpoint position. The actuating variable is provided in such a way that an equilibrium of forces acting on the actuator sets in at the specified setpoint position of the actuator.

### FIELD OF THE INVENTION

The present invention starts out from a method and a device for triggering an actuator in a mass-flow line.

### BACKGROUND INFORMATION

The triggering of a pneumatic actuator in a mass-flow line is already known. This may concern, for example, the mass-flow line of an internal combustion engine. Such a mass-flow line, for example, is an air inlet or an exhaust branch or a bypass channel, for example, to a turbine of an exhaust-gas turbocharger of the internal combustion engine. Furthermore, such a mass-flow line may be provided in an internal combustion engine with the aid of a pneumatic actuator also for changing the geometry of a turbine of such an exhaust-gas turbocharger.

### SUMMARY OF THE INVENTION

By contrast, the method according to the present invention and the device according to the present invention for triggering an, in particular pneumatic, actuator in a mass-flow line have the advantage that for setting the actuator a setpoint position is specified, that for setting the setpoint position an actuating variable is specified and that the actuating variable is specified in such a way that in the specified setpoint position of the actuator an equilibrium of forces acting upon the actuator is established. In this manner, the desired position of the actuator may be set precisely even without an automatic position control.

In this manner it is also possible to avoid overshooting effects that could result when setting the position of the actuator with the aid of an automatic control, particularly one having an integral-action component.

It is particularly advantageous if a current value is ascertained for a variable characteristic of a pressure or a pressure ratio in the mass-flow line in the region of the actuator, if the current value is compared with a reference value and if the actuating variable ascertained for setting the specified setpoint position of the actuator is corrected as a function of a deviation of the actual value from the reference value. In this manner it is possible to implement a low-cost empirical setting of the specified setpoint position without an automatic position control.

As a variable characteristic of the pressure or the pressure ratio in the mass-flow line in the region of the actuator, the use of a mass flow through the mass-flow line, of a first pressure upstream of the actuator in the mass-flow line or a pressure differential between a first pressure upstream and a second pressure downstream of the actuator in the mass-flow line have proved to be especially simple and inexpensive.

It is furthermore advantageous if the reference value for different actuating variables for triggering the actuator is ascertained under otherwise constant operating conditions. In this manner it is possible to form a characteristic curve for the reference value as a function of the actuating variable for triggering the actuator.

Another advantage results if the current value that was ascertained for a specified actuating variable is compared with the reference value associated with this specified actuating variable. In this manner, the triggering of the actuator may be corrected in a particularly reliable and precise manner.

The correction of the triggering of the actuator may occur in a particularly simple manner in that an additive or a multiplicative correction value for the triggering of the actuator is ascertained as a function of the deviation between the actual value and the reference value.

Another advantage results if the actuating variable is specified in such a way that in the specified setpoint position a resulting torque on the actuator becomes zero due to the forces acting on the actuator. In this manner it is possible to ascertain precisely the actuating variable required for setting the specified setpoint position with the aid of a mathematical model. For this purpose it is not necessary to ascertain reference values.

A particularly reliable and low-cost modeling is achieved if a first torque on the actuator is formed as a function of a pressure differential between a first pressure upstream and a second pressure downstream of the actuator in the mass-flow line, if a second torque is formed by a triggering force acting on the actuator and if a third torque is formed by a restoring force, particularly a spring force, acting on the actuator and if the sum of the three torques is set to zero for ascertaining the actuating variable required for implementing the specified setpoint position of the actuator.

### BRIEF DESCRIPTION OF THE DRAWINGS

FIG. 1 shows a schematic detail of an internal combustion engine including a mass-flow line and an engine control.

FIG. 2a shows a schematic view of the mass-flow line with an actuator in the closed position.

FIG. 2b shows a schematic view of the mass-flow line with the actuator in the open position.

FIG. 3 shows a flow chart for explaining the method according to the present invention and the device according to the present invention as shown in a first specific embodiment.

FIG. 4 shows another schematic view of the mass-flow line with the actuator in the closed position for explaining a second specific embodiment of the present invention.

FIG. 5 shows a flow chart for explaining the method according to the present invention and the device according the present invention as shown in a second specific embodiment.

### DETAILED DESCRIPTION

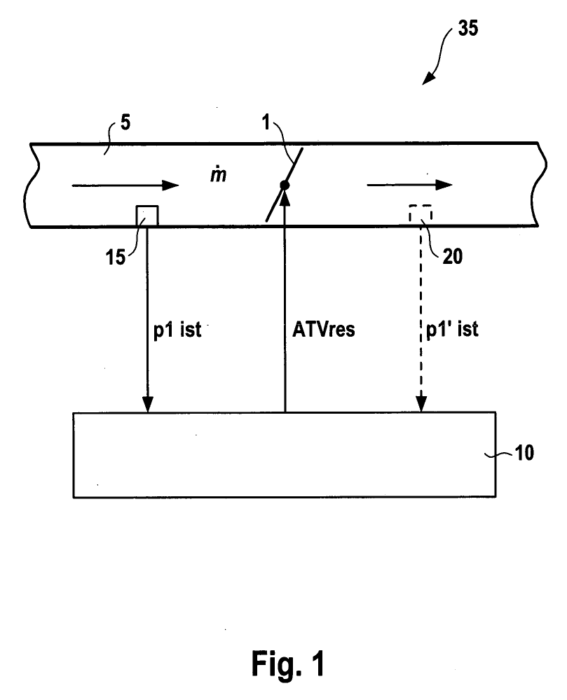

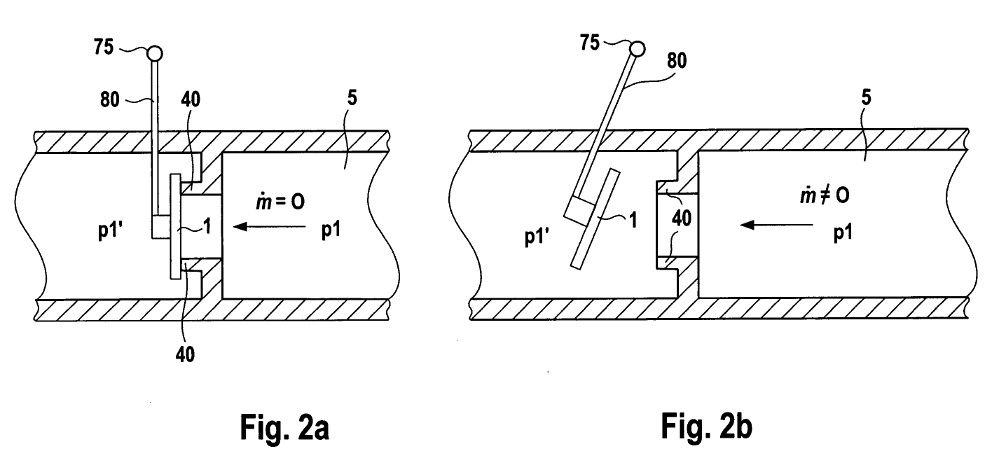

FIG. 1 schematically shows a detail of an internal combustion engine 35. Internal combustion engine 35 is able to drive a vehicle, for example. Internal combustion engine 35 may take the form of an Otto engine or a diesel engine, for example. As shown in FIG. 1, internal combustion engine 35 comprises a mass-flow line 5. Mass-flow line 5, for example, may be configured as an air inlet to internal combustion engine 35, an exhaust branch of internal combustion engine 35, a bypass of a turbine or a compressor of an exhaust-gas turbocharger of internal combustion engine 35 or for changing the geometry of a turbine of the exhaust-gas turbocharger. In principle, any mass-flow line of internal combustion engine 35 is suitable for the application of the method according to the present invention and of the device according to the present invention provided mass-flow line 5, as shown in FIG. 1, comprises an actuator 1 having a variable position. By changing the position of actuator 1, it is possible to influence or change the pressure ratios and the mass flow \dot{m} in mass-flow line 5. The method according to the present invention and the device according to the present invention can be applied to all types of actuators in which the position to which they are set results from an equilibrium of forces. In this regard it does not matter what drive concept is used to set the position of the actuator. Such an equilibrium of forces results particularly in actuators that take the form of a unilaterally supported valve and in which pressures act from both sides of the valve in mass-flow line 5. In the following it will be assumed in an exemplary manner that actuator 1 is such a unilaterally supported valve, as it is also shown in FIGS. 2a and 2b. Such a valve, for example, may be an exhaust-gas control valve or a waste-gate valve. FIG. 2a shows valve 1 in a closed state in mass-flow line 5. The direction of the mass flow in mass-flow line 5 in FIG. 2a is indicated by an arrow. In its closed position, valve 1 rests on a, for example, ring-shaped stop 40, which extends into mass-flow line 5 as shown in FIG. 2a. FIG. 2a shows a schematic sectional view of mass-flow line 5. A first pressure p1 prevails upstream of valve 1 in the mass-flow line, while a second pressure p1′ prevails downstream of valve 1 in mass-flow line 5 as shown in FIG. 2a. The unilateral support of valve 1 is achieved by a bearing 75, in which valve 1 is supported in such a way that it can be turned via a lever 80. In FIG. 2a, the unilateral support of valve 1 is intended to be shown only in a schematic manner and may be constructed in any other manner.

FIG. 2b then shows valve 1 in an opened position, identical reference numerals indicating the same elements in FIG. 2b as in FIG. 2a. As shown in FIG. 2b, valve 1 is deflected via lever 80 in the direction downstream of stop 40 such that the mass flow, which in FIGS. 2a and 2b is indicated by \dot{m}, is able to flow through the mass-flow line. According to FIG. 2a by contrast, the mass flow through mass-flow line 5a is prevented when valve 1 is closed, i.e. \dot{m} is in this case equal to zero. In the case of an open valve 1 as shown in FIG. 2b, mass flow \dot{m} is not equal to zero. FIG. 2b also indicates the first pressure p1 upstream of valve 1 as well as second pressure p1′ downstream of valve 1 in mass-flow line 5.

As stated, it is unimportant for the implementation of the present invention by what triggering concept the setting of the position of valve 1 is brought about. The triggering may occur electrohydraulically, for example, or electropneumatically or in any other manner. In the following it will be assumed in an exemplary manner that valve 1 is triggered by an electropneumatic transducer in the manner known to one skilled in the art, it being possible for the triggering to be clocked for example. Different positions of valve 1 may be set by different duty factors of the clocked triggering. For this purpose, an electrically clocked trigger signal may be used, for example, with the aid of which different positions of valve 1 may be set using different duty factors. The electrical trigger signal is transformed by an electropneumatic transducer into a pneumatic trigger signal, for example for use in a pressure box in a manner known to one skilled in the art. The setting of the position of valve 1 and thus the triggering of valve 1 therefore occurs in the end pneumatically. For this reason, the use of the electropneumatic trigger concept is assumed here in an exemplary manner, because the use of such pneumatic actuators or pneumatically triggered actuators in internal combustion engines normally occurs without position feedback such that an automatic control of the position of these pneumatic actuators is not possible.

In the following it is furthermore to be assumed in an exemplary manner that mass-flow line 5 is an exhaust-gas branch of internal combustion engine 35 and first pressure p1 upstream of valve 1 is thus an exhaust-gas counterpressure. According to FIG. 1, a first pressure sensor 15 is situated in exhaust-gas branch 5 upstream of valve 1, which measures an actual value p1ist for the exhaust-gas counterpressure and transmits the measured value to an engine control 10. Optionally, and as shown by a dashed line in FIG. 1, a second pressure sensor 20 may be situated downstream of valve 1 in exhaust-gas branch 5, which measures an actual value p1′ist for the second pressure downstream of valve 1 in exhaust-gas branch 5 and likewise transmits the measuring result to engine control 10. As shown in FIG. 1, the triggering of valve 1 is then likewise performed by engine control 10, this triggering in this example being based, as described before, on a trigger duty factor ATV, a resulting trigger duty factor ATVres being used to trigger valve 1 in accordance with the present invention.

The actual values p1ist and p1′ist may alternatively also be modeled from operating variables of internal combustion engine 35 in a manner known to one skilled in the art.

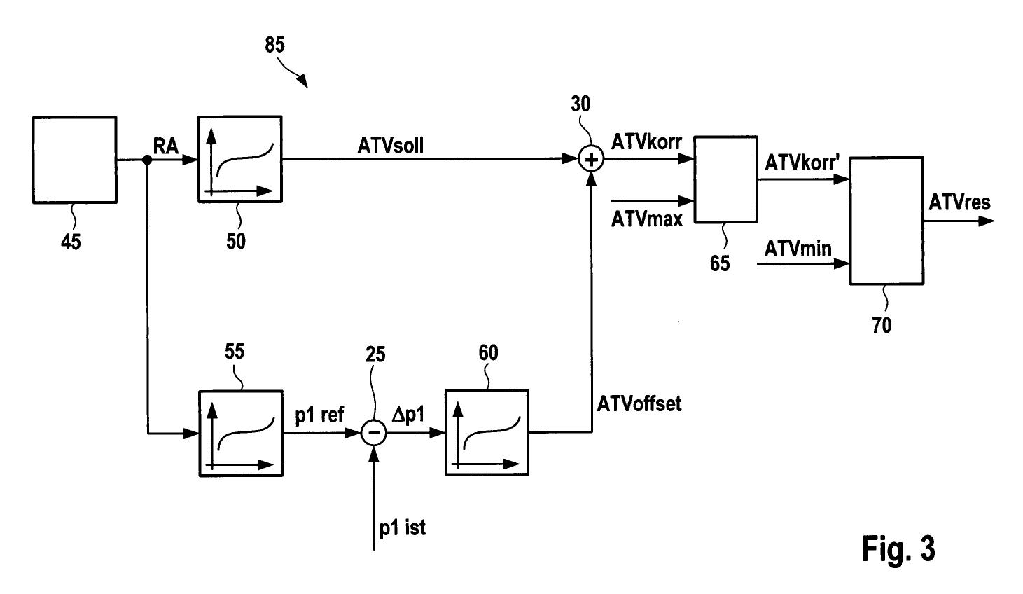

According to the present invention it is now quite generally provided that a current value for a variable characteristic of a pressure or a pressure ratio in mass-flow line 5 in the region of actuator 1 is ascertained, that the current value is compared with a reference value and that the triggering of actuator 1 is corrected as a function of a deviation of the current value from the reference value. In the following, exhaust-gas pressure p1 upstream of valve 1 is considered a variable characteristic of the pressure or the pressure ratio in exhaust-gas branch 5, considered here in an exemplary manner, in the region of valve 1, considered here in an exemplary manner. The current value for exhaust-gas counterpressure p1 is then the actual value p1ist for the exhaust-gas counterpressure ascertained by first pressure sensor 15. According to the present invention, this actual value p1ist for the exhaust-gas counterpressure is thus compared with a reference value. The triggering of valve 1 is thus corrected as a function of the deviation of the actual value p1ist of the exhaust-gas counterpressure from the reference value. Thus, as described, in the case of unilaterally supported valve 1, pressures act from both sides of valve 1 in exhaust-gas branch 5. This is on the one hand the exhaust-gas counterpressure p1 upstream of valve 1 and on the other hand the second pressure p1′ downstream of valve 1, it being generally the case that exhaust-gas counterpressure p1 is greater than second pressure p1′. The following describes how the reference value for the exhaust-gas counterpressure p1 may be ascertained. For this purpose, in uniform, i.e. constant operating conditions of internal combustion engine 35, different actuating variables for triggering valve 1, in this example different trigger duty factors, are specified particularly with respect to engine speed and engine load. For each of these trigger duty factors there is a corresponding exhaust-gas counterpressure p1, which is measured by first pressure sensor 15 and is stored in correlation to the associated trigger duty factor in a characteristic curve 55. The exhaust-gas counterpressures for the different trigger duty factors ascertained in this manner thus represent in each case a reference value p1ref for the exhaust-gas counterpressure in correlation to the associated trigger duty factor. The described characteristic curve may be ascertained on a test stand for example. Since valve 1 in the present example is to be positioned for setting a desired setpoint charging pressure using an exhaust-gas turbocharger of internal combustion engine 35, there may also be a provision for mapping the mentioned reference values p1ref for the exhaust-gas counterpressure in correlation to different output signals RA of a charging pressure controller 45 in the form of a characteristic curve as shown by the second characteristic curve 55 in FIG. 3. For this purpose, these output signals RA of charging pressure controller 45 are considered accordingly as actuating variables for triggering valve 1.

If later in the operation of internal combustion engine 35 valve 1 is actuated under different operating conditions of internal combustion engine 35 than those used as the basis for ascertaining second characteristic curve 55, then this will result in changed opening characteristics of valve 1. In particular the point of opening, that is, the trigger duty factor at which valve 1 begins to open from its closed state, may shift considerably. In order to take into account the dependence on the actual exhaust-gas counterpressures in the operation of internal combustion engine 35 under changed operating conditions than when ascertaining first characteristic curve 50, the actual value p1ist for the exhaust-gas counterpressure, which was ascertained for a specified trigger duty factor ATVsoll or was measured by first pressure sensor 15, can be compared with the reference value p1ref for the exhaust-gas counterpressure associated with this specified trigger duty factor ATVsoll in accordance with second characteristic curve 55. For the exhaust-gas counterpressure, the difference between reference value p1ref and actual value p1ist correlates with a difference of the forces acting on valve 1 in exhaust branch 5, which must be balanced by an appropriate triggering of valve 1. This means that the triggering, i.e. in this example the trigger duty factor for triggering valve 1, must be corrected accordingly.

FIG. 3 shows a flow chart representing a device 85 according to the present invention, which may be implemented in the form of software and/or hardware in engine control 10. The flow chart shown in FIG. 3 also explains the method according to the present invention in more detail. The charging pressure control already described is indicated in FIG. 3 by the reference numeral 45 and represents a part of device 85. Optionally, charging pressure control 45 may also be implemented outside of device 85. Charging pressure control 45 supplies output signal RA for minimizing a difference between a setpoint charging pressure and an actual charging pressure. In a first characteristic curve 50 of device 85, output signal RA of charging pressure controller 45 is converted into a setpoint value ATVsoll for the trigger duty factor of valve 1. For this purpose, first characteristic curve 50, for example, may be suitably applied on a test stand such that using the setpoint value ATVsoll for the trigger duty factor of valve 1, which is formed from output signal RA of triggering pressure controller 45, it is possible to correct the actual charging pressure to match the setpoint charging pressure as quickly and precisely as possible. Via second characteristic curve 55, which is likewise located in device 85, output signal RA of charging pressure controller 45 is mapped in the manner described in the correlated reference value p1ref of the exhaust-gas counterpressure. In a comparator unit 25 of device 85, which in this example takes the form of a subtraction element, the actual value p1ist is subtracted from reference value p1ref for the exhaust-gas counterpressure. The pressure difference Δp1 formed in the process is supplied to a third characteristic curve 60, which converts difference Δp1 into an offset value ATVoffset for the trigger duty factor. The third characteristic curve 60 may also be suitably applied on a test stand for example, so that the described force differential caused by pressure difference Δp1 may be compensated by valve 1 through offset value ATVoffset. In an summing element 30, offset value ATVoffset for the trigger duty factor is added to the setpoint value ATVsoll for the trigger duty factor. Summing element 30 in this case represents a correction unit for correcting the setpoint value ATVsoll for the trigger duty factor. Third characteristic curve 60 and summing element 30 are also components of device 85. The output of summing element 30 then provides a first corrected value ATVkorr for the trigger duty factor, which optionally and as shown in FIG. 3 is supplied to a minimum selection element 65, which on the other hand is supplied with a maximum admissible value ATVmax for the trigger duty factor as an input value. Minimum selection element 65 selects the smaller of the two input values and outputs this as the second corrected value ATVkorr′ for the trigger duty factor. Minimum selection element 65 thus represents a first limiting device, which upwardly limits the first corrected value ATVkorr for the trigger duty factor. Also optionally and as represented in FIG. 3, second corrected value ATVkorr′ may be supplied to a maximum selection element 70, which on the other hand is supplied with a minimum admissible value ATVmin for the trigger duty factor as an input value. Maximum selection element 70 selects the maximum of the two input signals and outputs it as the resulting trigger duty factor ATVres for triggering valve 1. Maximum selection element 70 thus represents a second limiting device, which downwardly limits second corrected value ATVkorr′. The maximum admissible value ATVmax and the minimum admissible value ATVmin for the trigger duty factor may likewise be suitably applied on a test stand for example, so that a desired operating range for the degree of opening of valve 1 to be set is defined by the two values ATVmax and ATVmin. As described, the two limitations are optionally provided, it also being possible to provide only one or none of the two limiting devices 65, 70. Accordingly, the limiting range for the degree of opening of valve 1 is limited by the two values ATVmax, ATVmin or only by one of the two values ATVmax, ATVmin or not at all.

Also the minimum selection element 65 and the maximum selection element 70 may be a component of device 85, but are not necessarily a component of device 85.

As also shown in FIG. 1, the resulting trigger duty factor ATVres is then used for triggering valve 1. The resulting trigger duty factor ATVres is thus supplied directly to the output stage for triggering valve 1.

Via output signal RA of charging pressure controller 45, first characteristic curve 50 and second characteristic curve 55, there is also a clear correlation between the respective setpoint value ATVsoll for the trigger duty factor and the corresponding reference value p1ref for the exhaust-gas counterpressure.

As an alternative to using the additive correction value in the form of the offset value ATVoffset for the trigger duty factor it is also possible to use a multiplicative correction value, the third characteristic curve 60 then converting the pressure differential Δp1 into a corresponding multiplicative correction value. In place of summing element 30, a multiplication element must then be provided for the correction unit, which is used to multiply the multiplicative correction value with the setpoint value ATVsoll for the trigger duty factor so as to form the first corrected value ATVkorr for the trigger duty factor.

In additional alternative specific embodiments it is also possible to select the volume flow through mass-flow line 5 as the variable characteristic of the pressure or the pressure ratio in mass-flow line 5 in the region of actuator 1, this volume flow being ascertainable in a manner known to one skilled in the art from operating variables of internal combustion engine 35. The observations made above for the exhaust-gas counterpressure are to be made in an analogous manner on the level of the volume flow.

In a further alternative specific embodiment it is also possible to select as a variable characteristic of the pressure or the pressure ratio in mass-flow line 5 in the region of actuator 1 a pressure differential between the first pressure upstream and the second pressure downstream of actuator 1 in mass flow line 5. In this case, the observations made above for the exhaust-gas counterpressure are to be applied in an analogous manner for the pressure differential across actuator 1, it being possible to form this pressure differential as the difference between the actual value p1′ist of the second pressure downstream of actuator 1 and the actual value p1ist of the first pressure upstream of the actuator. Alternatively it is also possible to situate a differential pressure sensor in the region of actuator 1 in the manner known to one skilled in the art for determining the pressure difference across actuator 1.

Generally, the method according to the present invention and the device according to the present invention can be applied in a corresponding fashion to any variable characteristic of the pressure or the pressure ratio in mass-flow line 5 in the region of actuator 1.

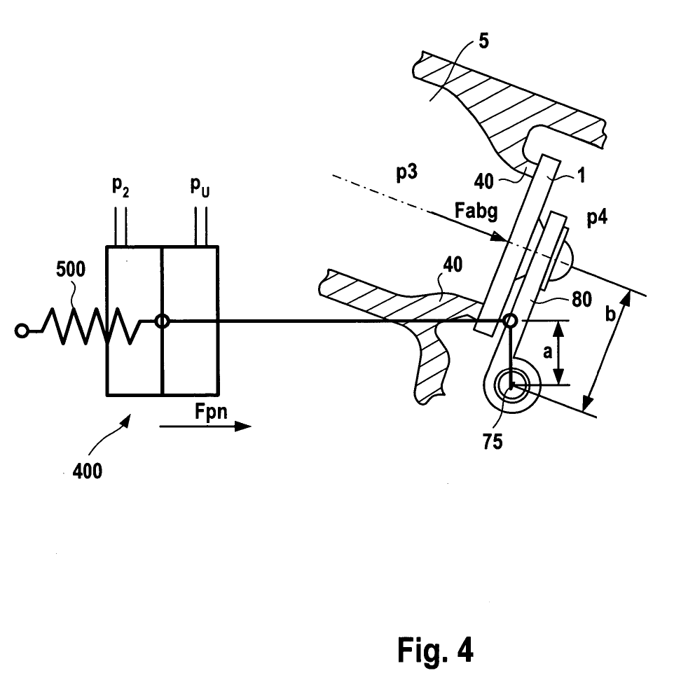

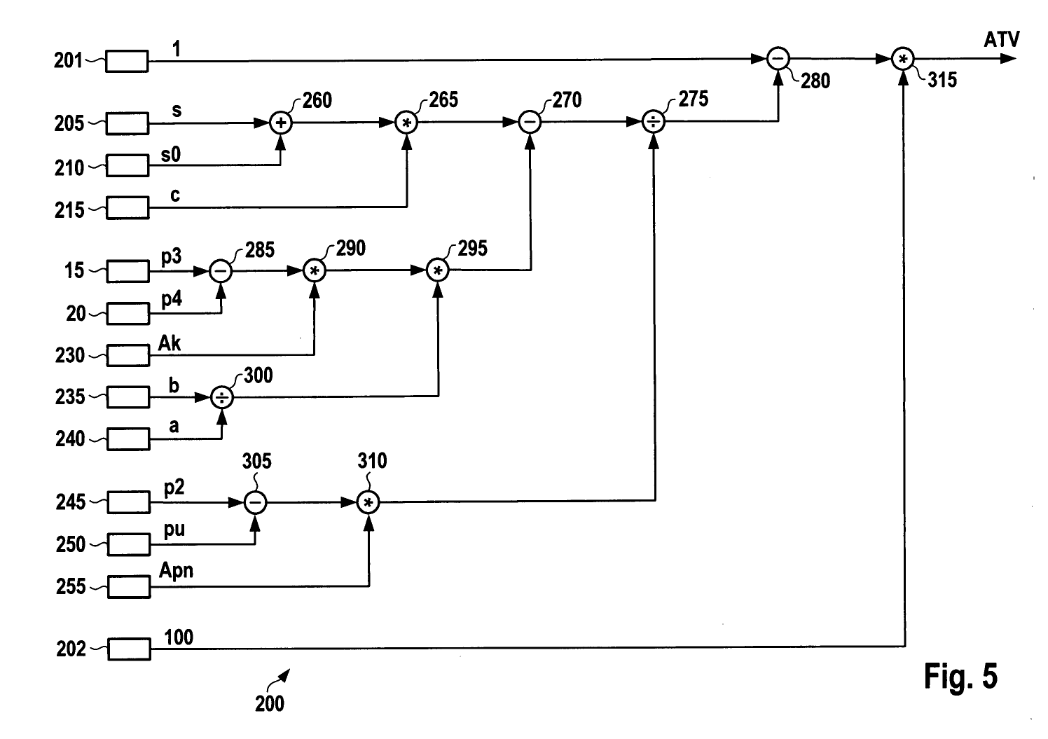

A second specific embodiment of the present invention is described below with reference to FIGS. 4 and 5. In analogy to FIG. 2a, FIG. 4 in this instance shows valve 1 in the closed state in mass-flow line 5. Identical reference numerals indicate the same elements in FIGS. 2a and 4. The direction of the mass flow in FIG. 4 is represented by the force Fabg, which for example represents an exhaust-gas counterforce resulting from an exhaust-gas counterpressure. First pressure p1 of FIG. 2a corresponds to a third pressure or exhaust-gas counterpressure p3 upstream of valve 1 in FIG. 4 and second pressure p1′ of FIG. 2a corresponds to a fourth pressure p4 downstream of valve 1 in FIG. 4. Exhaust-gas counterforce Fabg acts on an effective area Ak of valve 1, which approximately corresponds to the region of valve 1 bordered by the ring-shaped stop 40 and which is known in engine control 10. The lever arm for the exhaust-gas counterforce acting on valve 1 is indicated in FIG. 4 by b or has the length b. A pressure box 400 is supplied with a pressure differential, clocked at a trigger duty factor ATV, between a control pressure p2 and a reference pressure pu, for example an ambient pressure. The trigger duty factor ATV is normally stated in values between 0% and 100%. A duty factor of 0% normally means that a maximum pressure is available for pressure box 400. In the case of an Otto engine chargeable with a charging pressure p1 in an air-intake duct it is possible to use charging pressure p1 as control pressure p2. At a duty factor of 0% then the charging pressure p1 is applied completely to pressure box 400 and at a duty factor of 100% the ambient pressure pu is applied completely to pressure box 400. In additional specific embodiments it is possible to deviate from this convention, without thereby altering the principle. A triggering force Fanst results, which acts on the rod assembly or the lever 80 so as to open valve 1. Further, a restoring force Frück is formed for example by a spring 500 in order to close valve 1. Triggering force Fanst and restoring force Frück are superimposed on each other to yield a resulting force Fpn, which is indicated in FIG. 4. This resulting force Fpn acts on valve 1 via a lever arm of length a. The setpoint position of valve 1 to be set is clearly defined by a travel of spring s of spring 500 to be set accordingly. Spring 500 has an initial stress, for example, which results in a deflection s0. The total setpoint deflection of spring 500 resulting from the setpoint position of valve 1 to be set is thus s+s0. Restoring force Frück of spring 500 thus results in Frück=c*(s+s0), c being the spring constant known in engine control 10. When applying the difference, clocked at trigger duty factor ATV, between control pressure p2 and reference pressure pu, an effective diaphragm area Apn of pressure box 400 results in the triggering force

$${F}_{Anst} = {A}_{pn} ( {p}_{2} - {p}_{u} ) \frac{( 100 - ATV )}{100}$$

Thus the resulting force Fpn is

$${F}_{pn} = {A}_{pn} ( {p}_{2} - {p}_{U} ) \frac{( 100 - ATV )}{100} - {F}_{R \tilde{u} ck} .$$

As a simplifying assumption, valve 1 shall be considered as the effective area Ak described above, which has different pressures applied to it from both sides, namely, third pressure p3 and fourth pressure p4. Knowing pressures p3 and p4, exhaust-gas counterforce Fabg acting on valve 1 may be determined as follows: Fabg=Ak*(p3−p4). If the specified setpoint position of valve 1, that is, the specified total setpoint deflection s+s0 of spring 500, is to be set, then the requirement applies to the lever system of valve 1 that the resulting torque M around the swivel axis, i.e. the bearing 75 of valve 1, must be equal to zero. Thus for the resulting torque M=a*Fpn+b*Fabg=0.

This can be used to set up an equation, with the aid of which the required trigger duty factor ATV can be calculated as a function of the setpoint position of valve 1 to be set while maintaining a balance of forces between the mentioned forces Fabg, Fanst and Frück as follows:

$$ATV = 100 \cdot ( 1 - \frac{c ( s + s 0 ) - Ak ( p 3 - p 4 ) \frac{b}{a}}{Apn ( p 2 - pu )} ) \qquad ( 1 )$$

FIG. 5 shows a flow chart to illustrate the method of the present invention and the device of the present invention according to the second specific embodiment of the present invention. The flow chart shown in FIG. 5 forms an ascertainment unit 200 for ascertaining trigger duty factor ATV in accordance with equation (1), which is required to set the specified setpoint position of valve 1 and thus the associated total setpoint deflection s+s0 of spring 500 when there is an equilibrium of forces on valve 1. Ascertainment unit 200 may be implemented as software and/or hardware in engine control 10.

A first specifying unit 205 specifies the deflection s of spring 500 required for the setpoint position of valve 1 to be set. For this purpose, the connection between the different setpoint positions of valve 1 and the respectively associated deflection s of spring 500 may be applied for example in the form of a characteristic curve, for example on a test stand. With the aid of this characteristic curve, first specifying unit 205 then ascertains the associated deflection s of spring 500 from the specified setpoint position of valve 1. Deflection s0 caused by the initial stress of spring 500 is already known and permanently stored in a memory 210 associated with engine control 10. The equivalent holds true for the spring constant c, which is already known and permanently stored in a memory 215 associated with engine control 10. The equivalent applies to the effective area Ak of valve 1, which is already known and permanently stored in a memory 230 associated with engine control 10. Here it must be taken into consideration that the effective area Ak changes with the opening of valve 1, normally in the direction of smaller values. Thus here the value Ak for the effective area of valve 1 described previously for closed valve 1 only represents an approximation solution. The same is true of the lever arm of length a, which likewise changes with the opening angle of valve 1. Here a value is chosen by approximation for the length a of the lever arm when valve 1 is closed. Thus, on account of using the approximation values for Ak and a, an error results in ascertaining the trigger duty factor ATV according to equation (1) if valve 1 is not in its closed position. For the sake of simplicity, this error should be accepted here. The length a of the mentioned lever arm is already known and permanently stored in a memory 240 associated with engine control 10. The lever arm of length b or the length b itself is also already known and permanently stored in a memory 230 associated with engine control 10. Finally, the effective diaphragm area Apn of pressure box 400 is likewise already known and permanently stored in a memory 255 associated with engine control 10. Third pressure p3, which here represents an actual value for the exhaust-gas counterpressure, is supplied by first pressure sensor 15. Fourth pressure p4, here likewise an actual value, is supplied by second pressure sensor 20. Control pressure p2 is supplied by a third specifying unit 245. In the case of an internal combustion engine in the form of an Otto engine having an exhaust-gas turbocharger, the control pressure may be formed or specified for example by the charging pressure downstream of the compressor of the exhaust-gas turbocharger in the air-intake duct of the internal combustion engine. The third specifying means may then take the form of a charging pressure sensor for example. Charging pressure p2 for example may be supplied to pressure box 400 or to a pulse valve connected in the incoming circuit for implementing the trigger duty factor for example via an air line that branches off from the air-intake duct downstream of the compressor. In the case of an internal combustion engine in the form of a diesel engine, control pressure p2 may be supplied for example by a vacuum pump. Reference pressure pu, in this case the ambient pressure, may be ascertained by an ambient pressure sensor 250 for example. Ambient pressure pu for example may be supplied to pressure box 400 or to the pulse valve connected in the incoming circuit for implementing the trigger duty factor for example via an air line that branches off from the air-intake duct upstream of the compressor. A further memory 201 associated with engine control 10 stores the value 1. A further memory 202 associated with engine control 10 stores the value 100. The specifying units, pressure sensors or memories 201, 205, 210, 215, 15, 20, 230, 235, 240, 245, 250, 255 may respectively be part of ascertainment unit 200 or may be situated outside of it. The modules described in the following, however, are situated in ascertainment unit 200. Thus in a first summing element 260 the deflection s of spring 500 caused by the specified setpoint position of valve 1 is added to the deflection s0 caused by the prestress of spring 500. The sum formed is multiplied in a first multiplication element 265 by the spring constant c. The formed product is supplied to a first subtraction element 270. In a second subtraction element 285, the fourth pressure p4 is subtracted from third pressure p3. The resulting difference is multiplied by the effective area Ak of valve 1 in a second multiplication element 290. The resulting product is supplied to a third multiplication element 295. In a first division element 300, the length b is divided by the length a. The resulting quotient is multiplied by the output of second multiplication element 290 in third multiplication element 295. The product formed in this manner at the output of third multiplication element 295 is subtracted in first subtraction element 270 from the output of first multiplication element 265. The resulting difference is supplied to a second division element 275. In a third subtraction element 305, the ambient pressure pu is subtracted from control pressure p2. The resulting difference is multiplied by the effective diaphragm area Apn of pressure box 400 in a fourth multiplication element 310. In second division element 275, the output of first subtraction element 270 is divided by the product formed at the output of fourth multiplication element 310. The resulting quotient is subtracted in a fourth subtraction element 280 from the value 1 from memory 201. The output of fourth subtraction element 280 is then multiplied in a fifth multiplication element 315 by the value 100 from memory 202. The output of fifth multiplication element 315 then corresponds to the desired trigger duty factor ATV in percent according to equation (1).

The path of the second specific embodiment of the present invention provided here leads via a model-based description of the equilibrium of forces to an output of the trigger duty factor for setting the specified setpoint position of valve 1. This makes it possible, even without automatic position control, to achieve a precise triggering of valve 1 when specifying the desired setpoint position of valve 1.

The desired setpoint position of valve 1 may be specified for example as a degree or angle of opening or as a cross section or cross-sectional area.

Common to both specific embodiments is the fact that a setpoint position is specified for setting valve 1, that an actuating variable is specified for setting the setpoint position and that the actuating variable is specified in such a way that an equilibrium of forces acting on valve 1 sets in at the specified setpoint position of valve 1.

The advantage of the device according to the present invention and of the method according to the present invention is revealed for example in the case of a two-stage charging of internal combustion engine 85, in which valve 1 is used in a bypass for circumventing a high-pressure turbine in the exhaust-gas branch. This allows for an improvement of the transition of the charging pressure control from triggering valve 1 in the bypass of the high-pressure turbine to the triggering of a waste gate of the subsequent low-pressure turbine because the valve in the bypass of the high-pressure turbine can be set more precisely. The method according to the present invention may be regarded as a substitute for an automatic position control of actuator 1. As described, the method according to the present invention and the device according to the present invention may also be provided for a pneumatic actuator for setting the geometry of a turbine of an exhaust-gas turbocharger having a variable geometry, which also allows for the setting of the geometry to be made more precise and to be thereby improved.

The present invention was described above with reference to the mass-flow line of an internal combustion engine. It may be applied in a corresponding fashion to any mass-flow lines and is not limited to mass-flow lines in internal combustion engines.

What is claimed is:

1. A method for triggering an actuator in a mass-flow line, comprising:
specifying a setpoint position for setting the actuator; and
specifying an actuating variable for setting the setpoint position, the actuating variable benig specified in such a way that an equilibrium of forces acting upon the actuator sets in at the specified setpoint position of the actuator.

2. The method as recited in claim 1, further comprising:
ascertaining a current value for a variable characteristic of one of a pressure and a pressure ratio in the mass-flow line in a region of the actuator;
comparing the current value with a reference value; and
correcting the actuating variable as a function of a deviation of an actual value from the reference value.

3. The method as recited in claim 2, further comprising:
selecting a mass flow through the mass-flow line as the variable characteristic of one of the pressure and the pressure ratio in the mass-flow line in the region of the actuator.

4. The method as recited in claim 2, further comprising:
selecting a first pressure upstream of the actuator in the mass-flow line as a variable characteristic of the one of the pressure and the pressure ratio in the mass-flow line in the region of the actuator.

5. The method as recited in claim 2, further comprising:
selecting a pressure differential between a first pressure upstream and a second pressure downstream of the actuator in the mass-flow line as a variable characteristic of the one of the pressure and the pressure ratio in the mass-flow line in the region of the actuator.

6. The method as recited in claim 2, further comprising:
ascertaining, under otherwise constant operating conditions, the reference value for various actuating variables corresponding to duty factors for triggering the actuator.

7. The method as recited in claim 6, further comprising:
comparing a current value ascertained for a specified actuating variable with the reference value associated with the specified actuating variable.

8. The method as recited in claim 5, further comprising:
ascertaining one of an additive correction value and a multiplicative correction value for triggering the actuator as a function of a deviation between a current value and the reference value.

9. The method as recited in claim 1, further comprising:
specifying the actuating variable in such a way that in the specified setpoint position a resulting torque on the actuator turns to zero due to a force acting on the actuator.

10. The method as recited in claim 9, further comprising:
forming a first torque on the actuator as a function of a pressure differential between a first pressure upstream and a second pressure downstream of the actuator in the mass-flow line;
forming a second torque by a triggering force acting on the actuator;
forming a third torque by a restoring force acting on the actuator; and
setting to zero a sum of the first torque, the second torque, and the third torque for ascertaining the actuating variable required for implementing the specified setpoint position of the actuator.

11. The method as recited in claim 10, further comprising:
forming the triggering force by a pressure box as a function of a pressure differential applied on a diaphragm of the pressure box;
selecting the actuating variable as the duty factor at which one of a pressure supplied to the pressure box and a pressure differential supplied to the pressure box is clocked.

12. The method as recited in claim 1, wherein the actuator is supported unilaterally.

13. A device for triggering actuator in a mass-flow line, comprising:
a first arrangement for specifying a setpoint position for setting the actuator; and
a second arrangement for specifying an actuating variable for setting the setpoint position, wherein the second arrangement specifies the actuating variable in such a way that an equilibrium of forces acting on the actuator sets in at the specified setpoint position of the actuator.

14. The method as recited in claim 1, wherein the actuator is pneumatic.

15. The method as recited in claim 10, wherein the restoring force is a spring force.

16. The device as recited in claim 13, wherein the actuator is pneumatic.
